(19) United States
(12) Patent Application Publication
(10) Pub. No.: US 2012/0219926 A1
(43) Pub. Date: Aug. 30, 2012

(54) Cleaning Device for Teeth and Mouth, and Cleaning Methods

(75) Inventors: John P. Sullivan, Frankfort, IL (US); Michael D. LaMorte, Frankfort, IL (US)

(73) Assignee: S2L, LLC

(21) Appl. No.: 13/455,825

(22) Filed: Apr. 25, 2012

Related U.S. Application Data
(63) Continuation-in-part of application No. 13/134,882, filed on Jun. 20, 2011.
(60) Provisional application No. 61/397,962, filed on Jun. 18, 2010.

(51) Int. Cl. A61C 17/024; A61C 15/00

(52) U.S. Cl. 433/80; 132/200

(57) ABSTRACT

A flossing device cleans inside a mouth and essentially uses a water jet rather like a string of dental floss, to accomplish removal of particles between teeth. The device includes a mouthpiece that fits over the teeth. Advantageously no suction pump, nor power source, is included or needed in the device, which can be attached to a standard faucet. The device receives water from a standard faucet, which water exits the device from multiple holes in the mouthpiece.

### RELATED APPLICATIONS

This application is a CIP of USSN 13/134,882 filed Jun. 20, 2011 which claims benefit of provisional patent application 61/397,962 filed Jun. 18, 2010.

### FIELD OF THE INVENTION

The present invention pertains to the field of dental hygiene devices, and more specifically to the field of irrigating dental cleaning devices.

### BACKGROUND OF THE INVENTION

Brushing one's teeth is one of the most important parts of healthy hygiene. In addition to freshening the breath and strengthening the teeth, proper brushing also kills the germs and bacteria that can grow inside the mouth. Recently, the Office of the Surgeon General released its first ever report on oral health. According to the report, the most common chronic childhood disease by far in this country is tooth decay. Children lose 512 million school hours a year due to dental related illness. Adults also suffer from various forms of dental disease and these complications can lead to painful oral surgery and costly trips to the dentist. Nationwide, health expenditures for dental services exceeded $60 billion in 2007.

The American Dental Association (“ADA”) recommends that teeth should be brushed at least twice daily, preferably after meals. In addition to brushing, daily flossing has been the prescription for healthy teeth and gums offered by dental hygienists for over 80 years. However, according to an ADA survey, only 5% of adults floss daily. The American Academy of Periodontology lists many excuses offered for the lack of flossing, from bleeding gums to dexterity difficulties to the time-consuming nature of the practice.

The prior art has put forth several designs for irrigating dental cleaning devices. Among these are:

U.S. Pat. No. 3,731,675 to James J. Kelly describes an apparatus for cleaning and polishing teeth and particularly the interproximal surfaces and gingival crevices thereof wherein a mouthpiece adapted to fit over at least a portion of the dentition and sealably engage the gums. There are included a plurality of interiorly disposed spaced inlet and exhaust ports in communication with a source of fluid or other cleansing material and an evacuation pump.

U.S. Pat. No. 6,152,733 to Kenneth H. Hegemann, et al describes an automated hands-free personalized cleaning device for oral hygiene in which a robotic cleansing head is mounted for reciprocatable movement on a mounting base and is powered and controlled by a computer module.

U.S. Pat. No. 6,893,259 to Igor Reizenson describes an oral hygiene device including, in combination, a system for cleansing dental, inter-dental, gingival and deep-gum surfaces and crevices, and a teeth bleaching system.

The patent literature also includes the following:
U.S. Pat. No. 4,237,574 issued Dec. 9, 1980 to Kelly et al., for “Tooth Cleaning Apparatus.”
U.S. Pat. No. 4,793,331 issued Dec. 27, 1988 to Stewart, for “Shower Flossing System.”
U.S. Pat. No. 5,104,315 issued Apr. 14, 1992 to McKinley for “Oral Hygiene Device.”
U.S. Pat. No. 5,095,893 issued Mar. 17, 1992 to Rawden, Jr., for “Faucet Connected Oral Cleaning Device with Pulsating Flow.”
U.S. Pat. No. 5,387,182 issued Feb. 7, 1995 to Otani for “Faucet Mounted Water Jet Dental Hygiene Apparatus.”
U.S. Pat. No. 5,484,281 issued Jan. 16, 1996 to Renow et al., for “Showerhead Tooth Cleansing Apparatus.”
U.S. Pat. No. 6,305,617 issued Oct. 23, 2001 to Yu for “Oscillating Disk Dental Hygiene Device.”
U.S. Pat. No. 7,059,853 issued Jun. 13, 2006 to Hegemann (assigned to CRA Labs, Inc.), for “Oral Irrigation and/or Brushing Devices and/or Methods.”
US Patent Publication 2011/0027746 published Feb. 3, 2011 by McDonogh et al. (Johnson & Johnson), for “Oral Care Device.”
US Patent Publication 2011/0027748 published Feb. 3, 2011 by Fusi, II et al. (Johnson & Johnson), for “Oral Care Systems.”
US Patent Publication 2011/0027747 published Feb. 3, 2011 by Fougere et al. (Johnson & Johnson), for “Oral Care Device.”

However, despite all this work to date, dental cleaning devices thus far have suffered from various shortcomings and disadvantages. There remains an unmet need for simpler, easier to use cleaning devices in various contexts, such as, for example, that of a care giver caring for someone who has physical limitations that interfere with performance of one's own daily dental routine.

### SUMMARY OF THE INVENTION

It is an object of the present invention to provide an irrigating dental cleaning device.

The invention in a preferred embodiment provides an irrigating dental cleaning device, comprising a molded mouth-guard type mouthpiece configured in a U shape to conform to the contours of a set of human teeth, having a trough to receive the teeth, further comprising an irrigation water flow component at the front thereof consisting of an attachable tubing apparatus, allowing users to floss all of the teeth simultaneously by means of pressurized water, such as, e.g., inventive devices wherein the mouthpiece comprises a series of circular openings positioned along the perimeter of the mouthpiece, said openings serving as the egress for water, the device further comprising a force fit opening, which opening serves as the attachment point for the irrigation water flow component, wherein the irrigation water flow component comprises one central inlet nozzle, and two outlet nozzles, positioned on each side of the inlet nozzle, wherein all of these nozzles are designed to receive tubing by means of a force fit; inventive devices wherein the opposite end of the tubing attached to the inlet nozzle is a spout adapter that is configured to accommodate most sink faucets; inventive devices further comprising a small compartment with a cap that is attached to the inlet tubing, wherein the compartment is filled with mouthwash, and the mouthwash can be squeezed into the input line; inventive devices packaged within a durable plastic casing to protect the unit from airborne germs and bacteria when not in use; and other inventive devices.

The invention in a preferred embodiment provides a flossing device insertible into a mouth with teeth, comprising: a mouthpiece having an upper U-shaped cavity and a lower U-shaped cavity into which are received the teeth when the device is in place within the mouth; a faucet adapter, wherein the faucet adapter comprises a cavity into which is received a faucet in a watertight fit therebetween; an inlet hose mechanically connected on one end to the mouthpiece and on an opposite end to the faucet adapter; and at least one outlet hose mechanically connected to the mouthpiece, such as, e.g., inventive an flossing device comprising two outlet hoses; an inventive flossing device wherein the U-shaped mouthpiece is sized and shaped to fit into a mouth of a human; an inventive flossing device wherein the U-shaped mouthpiece is sized and shaped to fit into a mouth of an animal; an inventive flossing device further comprising a manifold, wherein the manifold comprises a first end that connects to the hoses and a second end that connects to a jet channel part (such an inventive device wherein at the manifold the device provides water pressure in a range of about 50 psi to 70 psi); an inventive flossing device wherein the U-shaped mouthpiece comprises a plurality of water jet channels through which water after having traveled from the faucet and through the inlet hose, exits into the mouth; an inventive flossing device wherein the U-shaped mouthpiece comprises a plurality of water collection channels through which are collected water from the mouth, wherein each water collection channel empties towards one or both of the outlet hoses; an inventive flossing device in which used water exits the mouth based on water pressure applied when a faucet is connected to the faucet adapter and the faucet is open, without any suction pump; an inventive flossing device of claim 1, comprising a plurality of water jet holes having a diameter or a dimension in a range of 0.015 inch to 0.05 inch; an inventive flossing device comprising a plurality of water jet holes in a range of 58 holes to 72 holes; an inventive flossing device wherein the inlet hose has an inner diameter of about 0.125 inch; an inventive flossing device wherein each outlet hose has an inner diameter of about 0.25 inch; an inventive flossing device wherein the inlet hose, which is straight or coiled or a combination thereof, has a length in a range of about 6 inches to 36 inches; an inventive flossing device comprising at least one water jet channel having a slanted sidewall (such as, e.g., a slanted sidewall having an angle of the slanted sidewall in a range of about 40 to 70 degrees (with 55 degrees being a preferred angle of the slanted sidewall), wherein the slanted sidewall begins at an inner end relatively inside the device and ends at a water-emerging end where water exits the device into the mouth, and the slanted sidewall is angled such that a cross-section of the water jet at the inner end is wider than a cross-section of the water jet at the water-emerging end; and other inventive flossing devices.

In another preferred embodiment the invention provides a flossing device insertible into a mouth with teeth, comprising: a mouthpiece shaped to fit into the mouth and comprising an upper U-shaped cavity and a lower U-shaped cavity into which are received the teeth; a faucet adapter, wherein the faucet adapter comprises a cavity into which is received a faucet in a watertight fit therebetween; at least one outlet through which used water travels away from the mouth; provided that no suction pump is included in or connected to the flossing device, and no power source is included in or connected to the flossing device. Preferably the inventive flossing device includes two outlets through which used water travels away form the mouth.

The invention in a further preferred embodiment provides a cleaning method for teeth within a mouth, the method not including use of a suction pump, comprising the steps, after a mouthpiece has been inserted into the mouth, of delivering water jets into the mouth through a plurality of water jet channels constructed in the mouthpiece, wherein water exiting the mouthpiece has a pressure in a range of about 50 psi to 70 psi measured at the mouthpiece (such as, e.g., a step of delivering water jets that includes angling a water jet, upon exiting a hole, at an angle wherein the water jet travels an angled path in a range of 40 to 70 degrees from horizontal); dislodging food particles between the teeth by force of the delivered water in the step of delivering water jets; collecting used water and dislodged food particles from the mouth; and, for the used water including food particles that have been collected, receiving used water in at least one outlet hose wherein the used water travels away from the mouth via the outlet hose (such as, e.g., a receiving step that comprises receiving used water in two outlet hoses), wherein the delivering, dislodging, collecting and receiving steps are performed using a unitary device that comprises the plurality of water jet channels, the mouthpiece, and the outlet hose. Preferably the inventive method comprises a step of inserting into the mouth a mouthpiece having an upper U-shaped cavity and a lower U-shaped cavity into which are received the teeth when the device is in place, followed by positioning the mouthpiece so that the teeth are within the upper U-shaped cavity and the lower U-shaped cavity. Preferably the inventive method includes, before the step of delivering water into the mouth, attaching a faucet adapter to a faucet, followed by turning on the faucet and receiving water from the turned-on faucet through the faucet adapter, which water is channeled for use in the delivering step. Preferably the inventive cleaning method is practiced in connection with manually turning on a standard faucet, and practiced without operating any suction pump, and further practiced without operating any motorized device.

In another preferred embodiment, the invention provides a cleaning method for teeth within a mouth, the method not including use of a suction pump or motor, comprising the steps, performed by a device in which no suction pump or motor is included or attached, of: receiving clean water from a standard faucet by a part of the device into which is received the clean water, wherein the receiving part has an inner cross-sectional surface area where the faucet joins with the device; after receiving the clean water from the standard faucet, receiving the clean water in a mouthpiece of the device; after receiving the clean water in the mouthpiece, ejecting the water out of the mouthpiece into the mouth (such as, e.g., a water-ejecting step in which the clean water exits the mouthpiece through a plurality of holes, wherein each hole has a cross-sectional surface area where the water exits the mouthpiece, and a sum of total cross-sectional surface area of all the holes of the plurality of holes is less than the inner cross-sectional surface of the part of the device that receives clean water from the faucet); dislodging food particles from between teeth, to form dirty water, wherein the dislodging is performed by the clean water that has been ejected from the mouthpiece into the mouth; receiving the dirty water, wherein the receiving of the dirty water is performed by the mouthpiece and the dirty water travels into the mouthpiece; after receiving the dirty water into the mouthpiece, discharging the dirty water out of the mouthpiece towards a sink associated with the faucet, wherein the discharging step is performed by the device if clean water continues to be received into the device from the faucet; followed by discharging the dirty water out of the device into the sink.

### BRIEF DESCRIPTION OF THE DRAWINGS

FIGS. 1-10 depict a first exemplary embodiment of a device according to the present invention, as follows:

FIG. 1 is an elevational angled perspective front view of the device having an irrigation water flow component attached;

FIG. 2 is an elevational angled perspective rear view of a mouth piece 1 portion of the device;

FIG. 3 is a side view of the device having an irrigation water flow component 3 attached;

FIG. 4 is a top view of the device having an irrigation water flow component 3 attached, showing a water inlet center nozzle 6 and water outlet nozzles 7A, 7B;

FIG. 5 is a side view of internal components of the device having an irrigation water flow component 3 attached;

FIG. 6 is a top view of internal components of the device having an irrigation water flow component 3 attached;

FIG. 7 is a front view of the device;

FIG. 8 is a back view of the device;

FIG. 9 is an elevational angled perspective front view of the mouth piece 1 portion of the device;

FIG. 10 is a cutaway view of the mouthpiece 1 showing nozzles 9 for inflow of water flow and an outlet channel 10 for outflow of water.

FIGS. 11-21B depict a second exemplary embodiment of a device according to the present invention, as follows:

FIG. 11 is a front perspective view including mouthpiece 1101;

FIG. 12 is a rear perspective view depicting underside jet hole 1204 which is one of a plurality of holes for underside jets;

FIG. 13 is an exploded view corresponding to FIG. 11;

FIG. 14 is an exploded view corresponding to FIG. 12;

FIG. 15 is a top view depicting a jet hole 1504 which is one of a plurality of holes for jets;

FIG. 16 is a front view;

FIG. 17 is a rear view including jet seat 1700;

FIG. 18 is a side view showing the upper mouthpiece 1800 and the lower mouthpiece 1801 of mouthpiece 1101;

FIG. 19 is a part of FIG. 15 and FIG. 19A is an enlarged cross-sectional view showing a cross-section E-E marked in FIG. 19.

FIG. 20 is a part of FIG. 15 and FIG. 20A is a cross-sectional view along the line H-H in FIG. 20. FIG. 20B is an enlarged view of part of FIG. 20A.

FIG. 21 is a part of FIG. 15 and FIG. 21A shows section B-B referring to the line B-B in FIG. 21. FIG. 21B is an enlarged view of part of FIG. 21A.

FIG. 22 is a flow chart of a preferred embodiment of an inventive cleaning method in which is used an inventive device.

FIG. 23 illustrates water flow (represented by arrows) through an embodiment of an inventive device.

### DETAILED DESCRIPTION OF A PREFERRED EMBODIMENT OF THE INVENTION

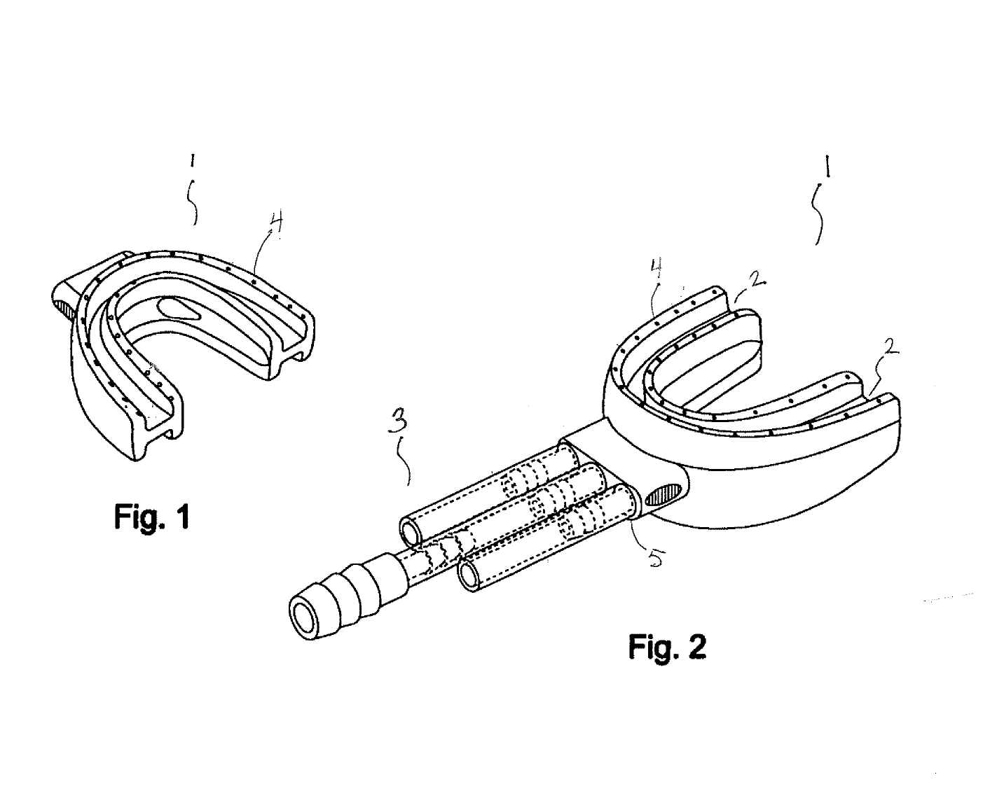

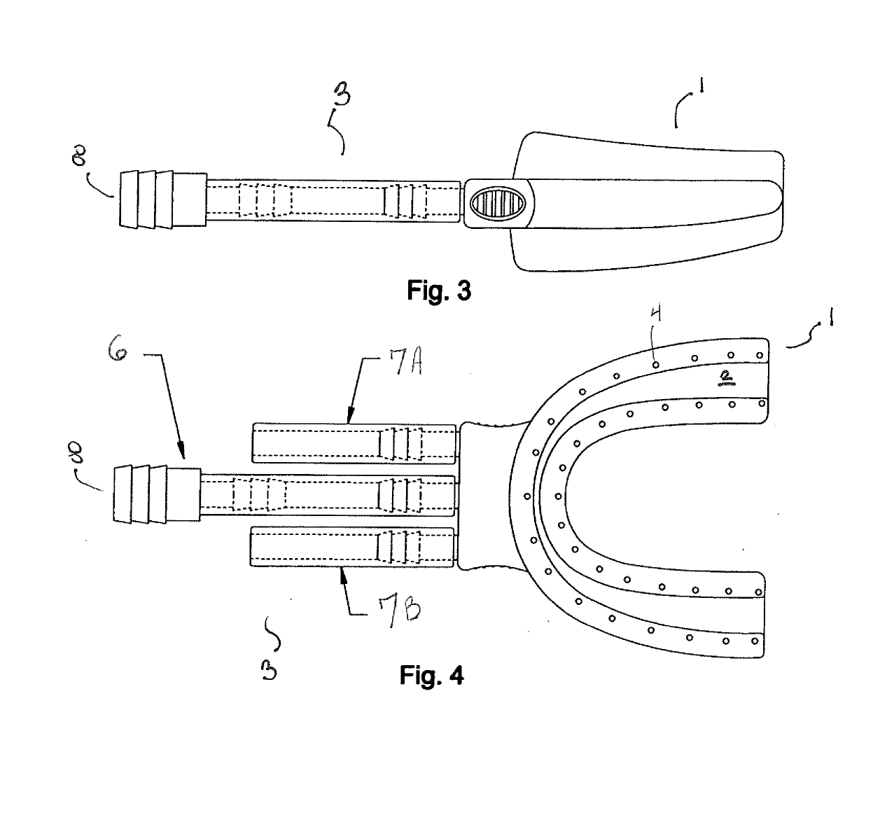

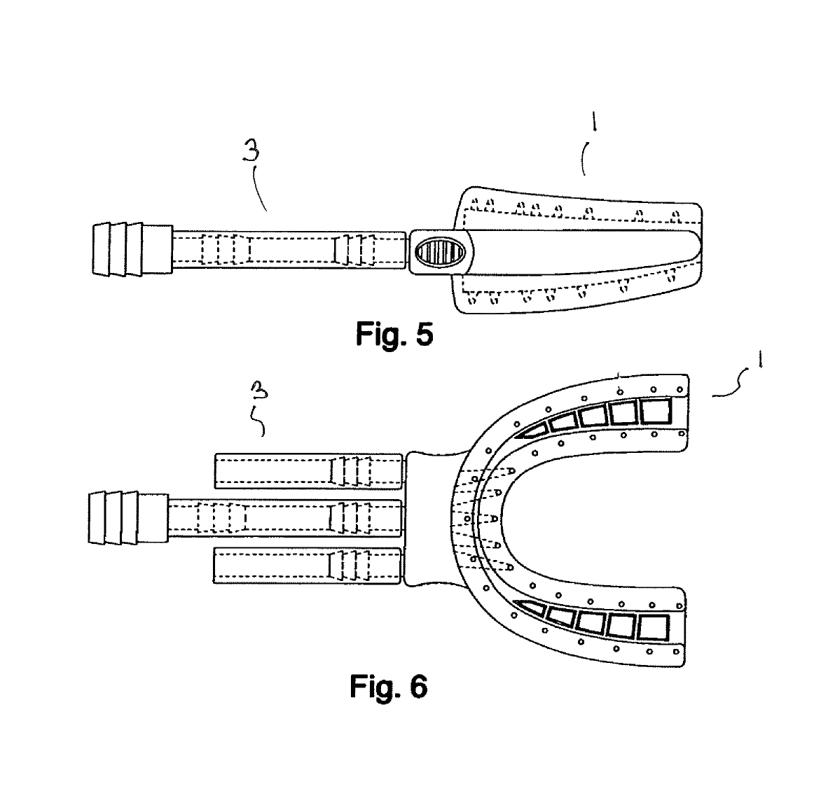

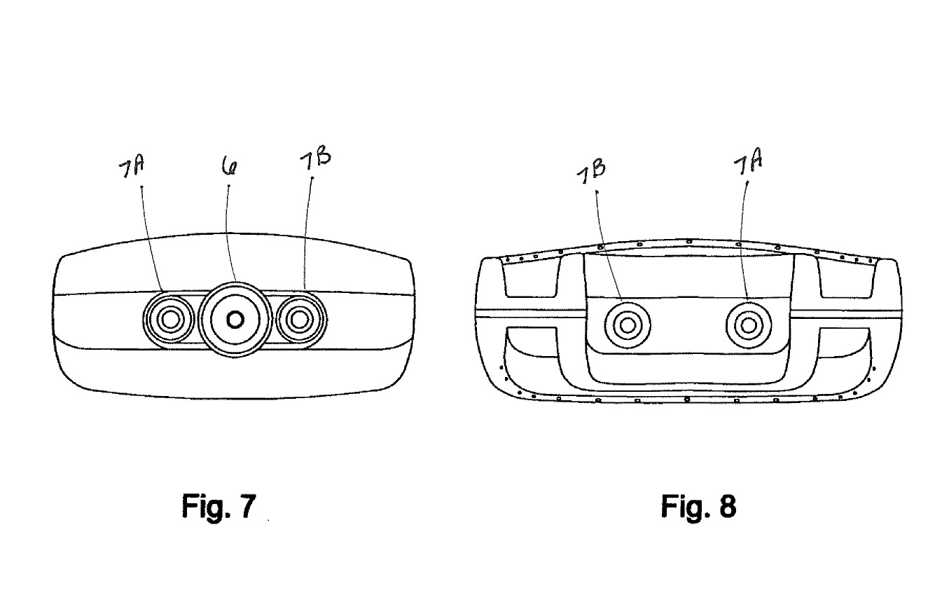

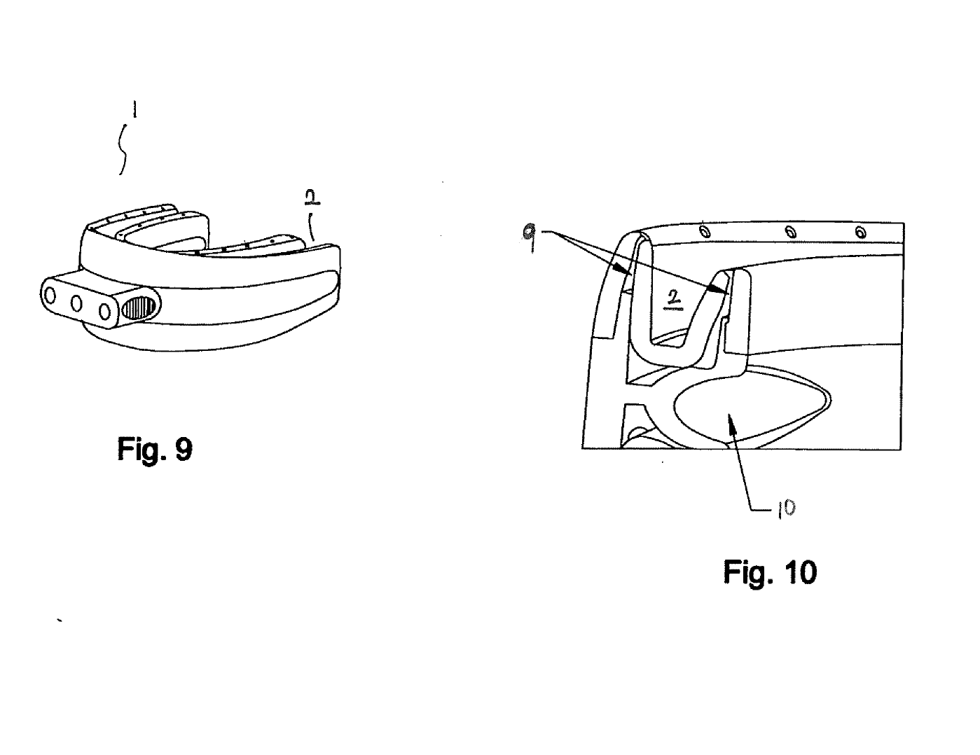

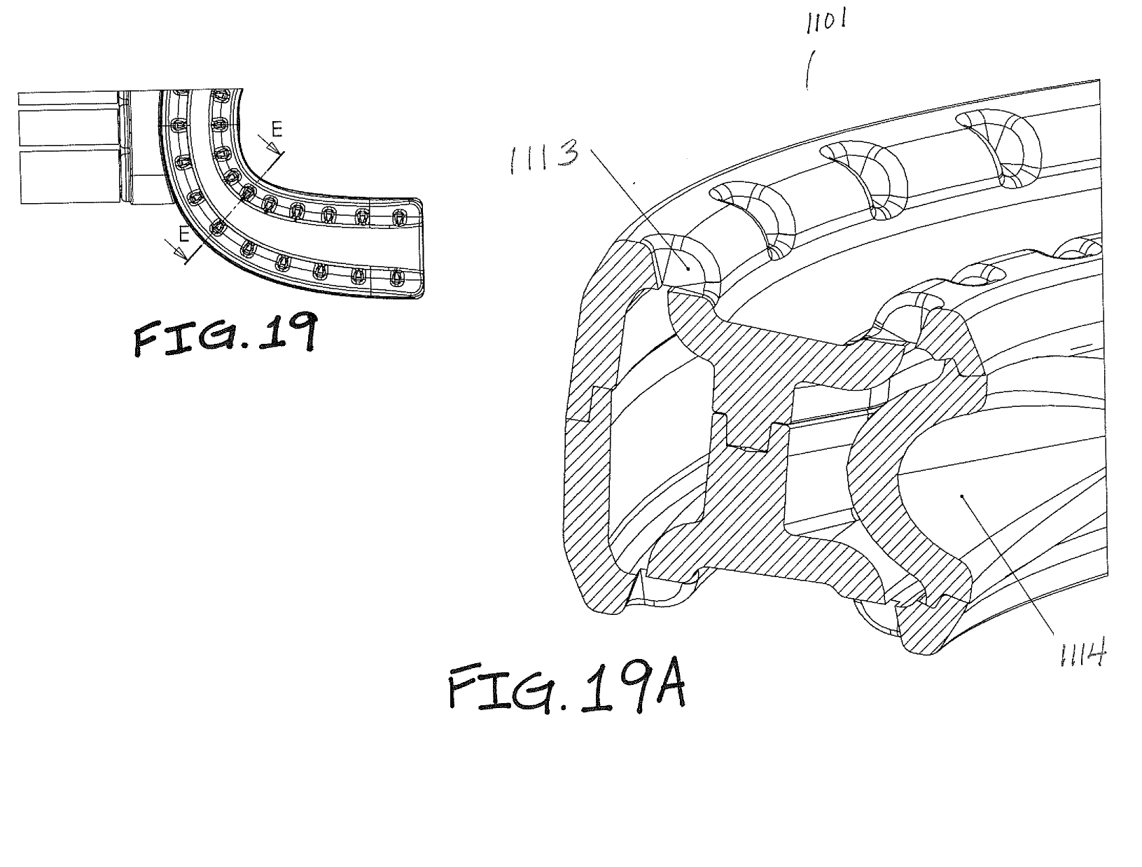

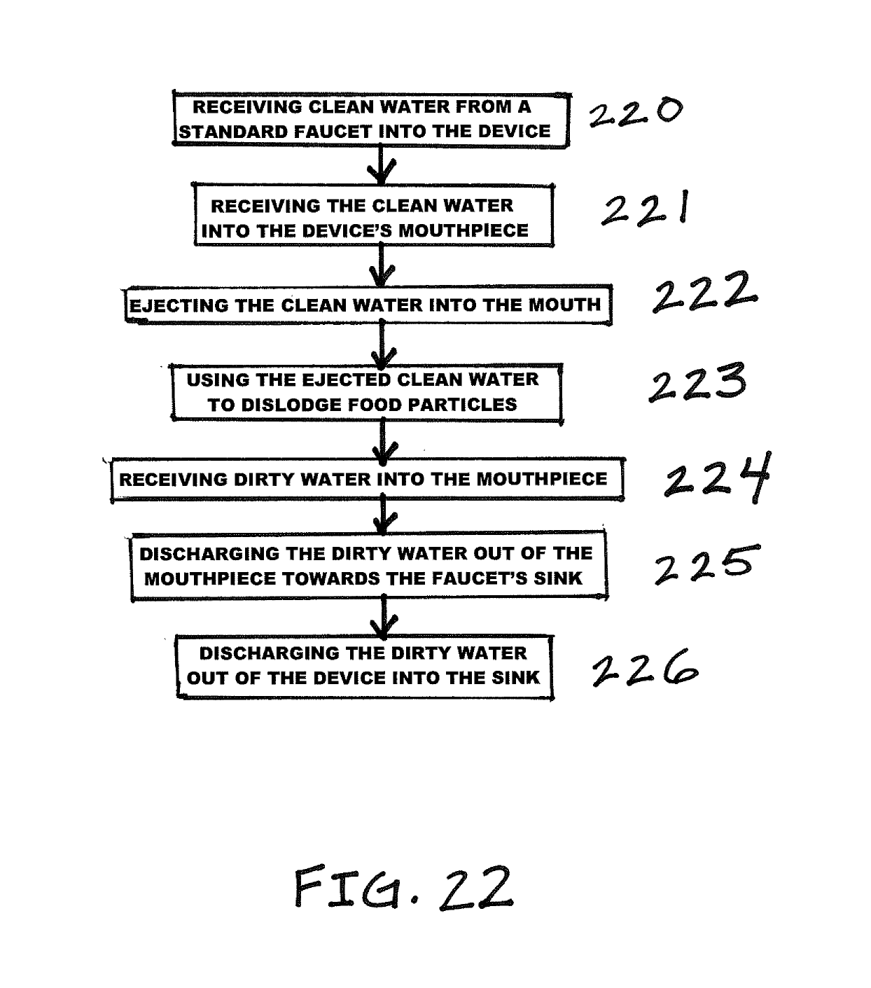

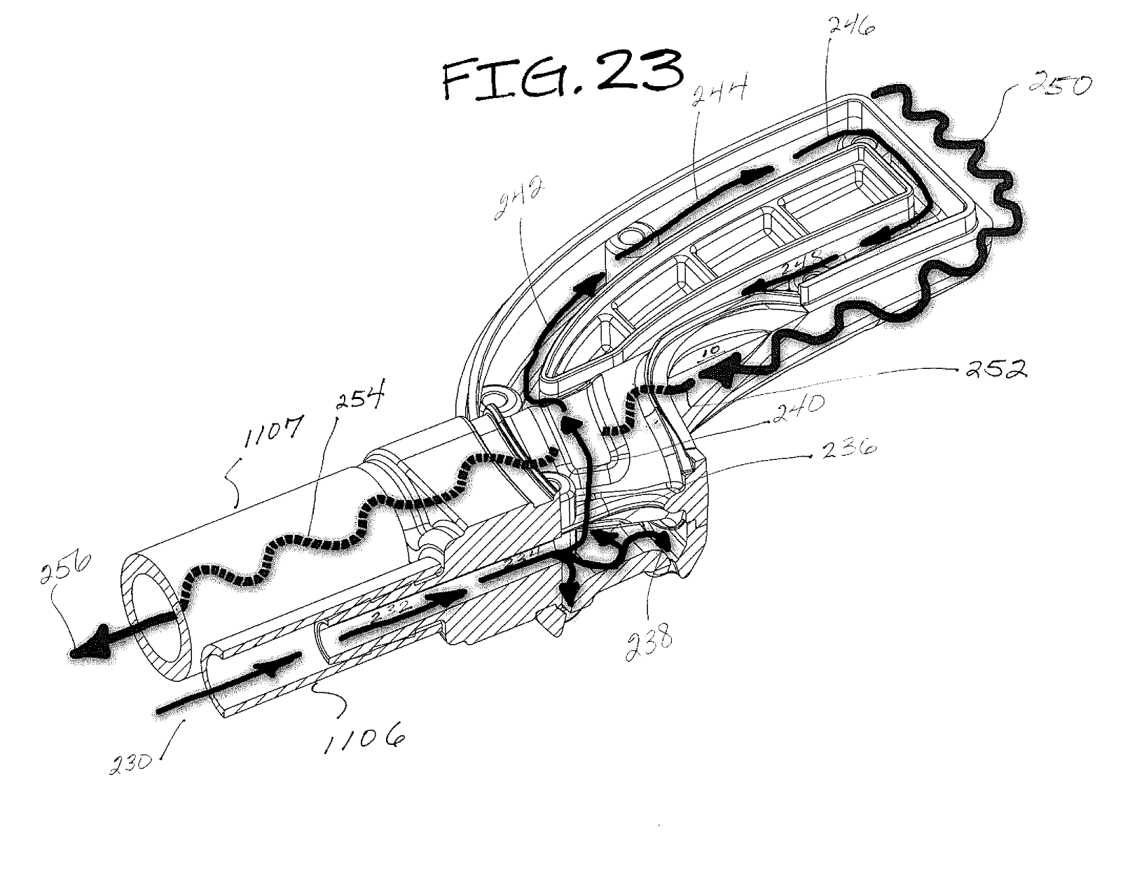

The present invention provides a device which may be called, e.g., a mouth-cleaning device or a flossing device. By “flossing”, we refer to the generalized dislodging of particles between teeth, and not to use of dental floss in string form. An exemplary inventive cleaning method comprises method steps shown in FIG. 22 and is performed using a device (such as, e.g., devices illustrated in FIGS. 1-21B), preferably a device that connects to a standard water faucet, with the method steps of FIG. 22 being performed after the device has been connected to the water faucet.

A step 220 of receiving clean water from a standard faucet into the device is performed. A preferred example of receiving 220 clean water from the faucet into the device is receiving the clean water via a faucet adapter, wherein the faucet adapter snugly joins the device to the faucet. Once the device has been attached to the water faucet and the water faucet has been turned on manually, preferably the device itself performs step 220 of receiving the clean water from the faucet into itself.

The step 220 of receiving the clean water into the device is followed by receiving 221 the clean water into the mouthpiece of a device (such as, e.g., a device comprising the mouthpiece, a faucet adapter and a hose connecting the faucet adapter to the mouthpiece), wherein water-receiving is performed by the mouthpiece. In a preferred example, the clean water enters the device through a faucet adapter part of the device, and then passes from the faucet adapter into a hose and from the hose into the device's mouthpiece.

The step 221 of receiving the clean water into the device's mouthpiece is followed by a step of ejecting 222 the clean water into the mouth. According to the invention, when the device used in the method is connected to a standard water faucet, and when the water faucet is turned on and kept on for a period of time, clean water is ejected out of the device into the mouth of a to-be-flossed individual by operation of the further clean water entering the mouthpiece behind the clean water that is being ejected. Preferably the ejecting step 223 comprises ejecting the clean water from a plurality of holes in the mouthpiece. In order for the ejected clean water to be pressurized enough to operate as intended within the mouth, preferably the water is ejected from a plurality of holes (openings) in the mouthpiece where the total of the cross-sectional surface areas of the respective holes (measured at the points where the clean water is ejected from the mouthpiece) is an amount that is smaller than the cross-sectional surface area of the device where the device receives the clean water from the faucet. When making the mouthpiece, the total number of the holes, and the cross-sectional area of the holes, is selected so that the clean water when being ejected is ejected under sufficient pressure to perform a cleaning operation.

When constructing a mouthpiece for use in human mouths, preferably each hole has a diameter in a range of between about 0.015 inch to 0.05 inch. If the hole is smaller than 0.015 inch, a mold-ability problem is presented when constructing the mouthpiece, and in use there may be a risk of back pressure. If the hole is bigger than 0.05 inch, there can be a problem with loss of pressure. Although we mention “diameter” herein for describing size, it should be appreciated that a hole is not required to be circular, and other shapes can be constructed, such as, e.g., rectangular, etc.

When constructing a mouthpiece for use in human mouths, preferably a number of holes is in a range of 58 to 72.

The step 223 of ejecting the clean water into the mouth is followed by dislodging 223 food particles by using the ejected clean water to dislodge food particles. Namely, clean water that has been ejected out of the device operates to dislodge food particles from between teeth. When the mouthpiece is constructed, preferably a pattern of the holes from which the clean water is ejected from the mouthpiece is selected to aim ejected clean water at gaps between teeth. However, it will be appreciated that individuals may have a variety of tooth spacing, such as due to having had orthodontic work or otherwise. Therefore preferably the mouthpiece is constructed so that when the mouthpiece is in use, the mouthpiece can be wiggled or moved somewhat during operation of the water delivery, as needed, so that pressurized water will be able to perform the dislodging 223.

After food particles have been dislodged by the dislodging 223, the device performs a step 224 of receiving dirty water (including the food particles) into the device's mouthpiece. The mouthpiece should be constructed so that the device performs the dirty-water-receiving step 224, that is, that the dirty water goes into the mouthpiece at an intended exit location(s) for dirty water, rather than the dirty water spit itself out of the mouth, and/or go down the throat. To accomplish the dirty-water receiving step 224, the mouthpiece is constructed to include at least one exit channel that is oriented in a direction of where the dirty water is in the mouth and that receives the dirty water from the mouth.

After the step, performed by the device, of receiving 224 the dirty water into the device's mouthpiece, a step is performed of discharging 225 the dirty water out of the mouthpiece towards the faucet's sink.

After the step, performed by the device, of discharging 225 the dirty water out of the mouthpiece towards the faucet's sink, a step 226 is performed of discharging the dirty water out of the device into the sink.

Preferably, the method steps of FIG. 22 are performed by a device that is attachable to a standard faucet and that comprises a mouthpiece, wherein the device makes use of clean water from a standard faucet, and wherein the device disposes of dirty water (including food particles collected by device and taken away from the mouth) into a sink associated with the faucet. For example, the invention provides an inventive flossing device that in operation, performing the method steps of FIG. 22, cleans inside a mouth of a to-be-flossed individual and essentially uses a water jet rather like a string of dental floss, to accomplish removal of particles between teeth.

A preferred example of a mouthpiece for use in the method steps of FIG. 22 is a mouthpiece that fits over the teeth of a to-be-flossed individual, most preferably with a loose-ish fit that permits the mouthpiece to be wiggled somewhat in operation.

Advantageously an inventive method comprising the steps in FIG. 22 is practiced without any suction pump, and without any power source, being included in or attached to the device. Advantageously, the invention provides devices to a standard faucet, and methods that can be practiced using a standard faucet.

When constructing an inventive device to use (such as for practicing the method steps in FIG. 22), preferably a mouthpiece manifold is constructed using two polypropylene duplicate parts, sandwiched around a connector-collector part, and adhered (such as, e.g., sonically welded). Such an arrangement allows for varying sizes of the water jet delivery part (i.e., the two identical parts) to fit one connector-collector part.

When constructing a device according to the invention and for use in humans, it should be considered that different people have different-size bites. One way to accommodate all human mouth sizes is to design three distinct-sized mouthpieces (all sharing the same mouthpiece manifold part). Another approach is to construct a middle size in a lower durometer (softer) material which can flex to each mouth shape. However, use of a lower durometer material to construct the mouthpiece tends to produce a less-durable product, is also a more costly production methodology, and results in a product that is prone to allowing the water channels to get “pinched off.” Examples of materials useable for constructing the mouthpiece are, e.g., silicone; polypropylene; etc.

For transporting water within the device to accomplish the inventive method steps of FIG. 22, such as the mouthpiece's receiving clean water, and the mouthpiece's discharging of the dirty water towards the sink, a suitable water-transportation part can be used, such as, e.g., one or more hoses, such as, e.g., a hose made of an ether-based polyurethane material, a hose that meets National Sanitation Foundation specifications (NSF-61), etc.

Examples of a hose's form are, e.g., straight, coiled, a combination thereof.

A preferred example of a hose length is in a range of about 6 to 36 inches. A 6-inch hose preferably would be used in straight form. A 36-inch hose preferably would be used in coiled form.

When constructing a device using a manifold construction such as that of Example 2 below, design choices are preferred such that the water pressure is at least 50 psi (to maintain positive water-jet action in the mouthpiece) but not greater than 70 psi (to prevent manifold blowout which could cause damage to the mouthpiece 1101).

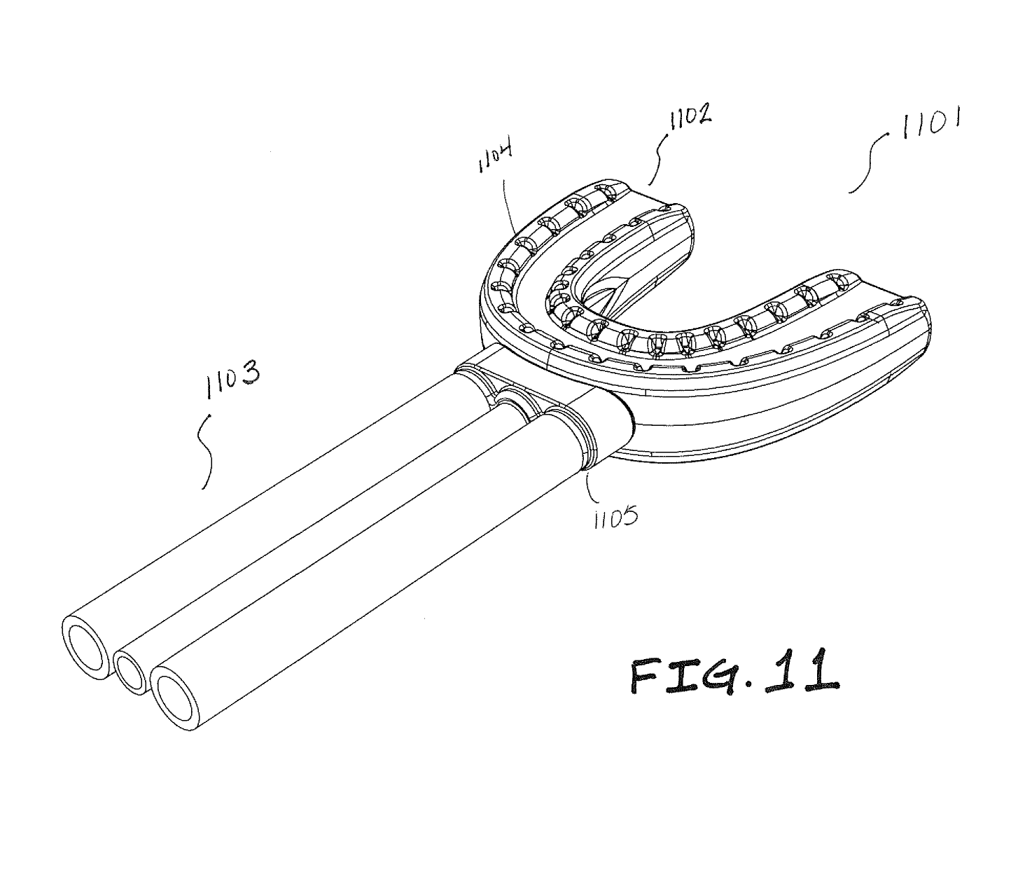

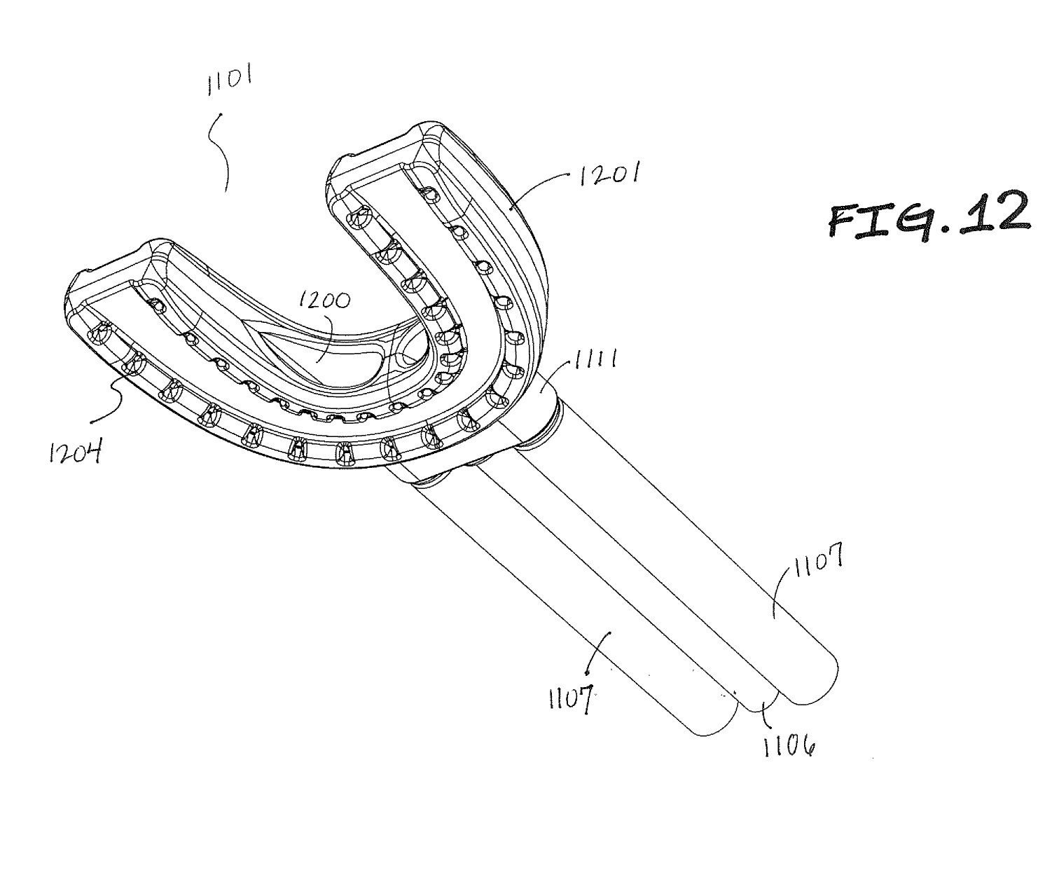

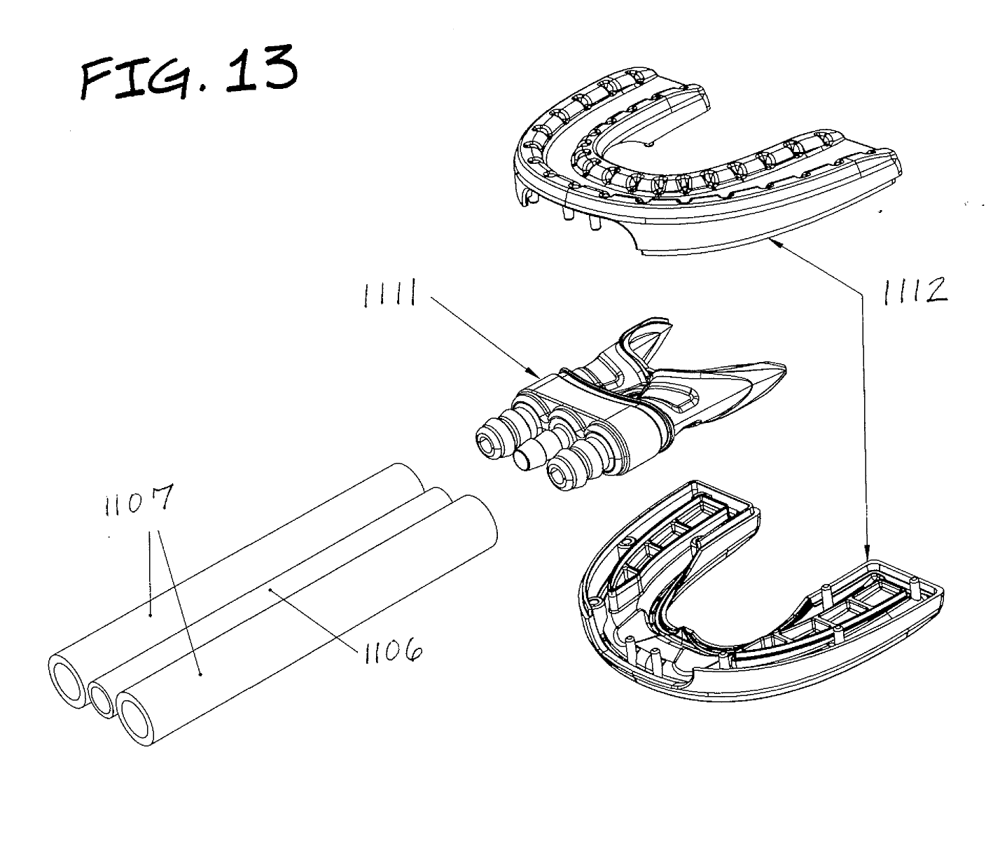

In the invention, flow of water (shown as arrows in FIG. 23) is managed to accomplish the cleaning objective invention without having water undesirably travel down the throat of someone in whom the device is being used, and without having water spurt out of the front of that person's mouth. Incoming water 230 which is clean water from a faucet travels via an inlet nozzle 1106 which preferably is a central inlet nozzle, and moves through the inventive device (such as shown as water pathway 232, 236, 238, 240, 242, 244, 246, 248. Water 250 has emerged from the device and is outside the device but inside the mouth. The arrow of water 250 shows that the water in the mouth is being drawn back into the device (such as at channel 10 (FIG. 10) that receives water leaving the mouth). The outgoing water pathway is shown as 252, 254, and exiting water 256.

A preferred water direction approach to use in constructing a device according to the invention is to direct water (from the faucet) into, through, and out of the device, which then collects waste water and directs the waste water to exit holes (preferably two exit holes).

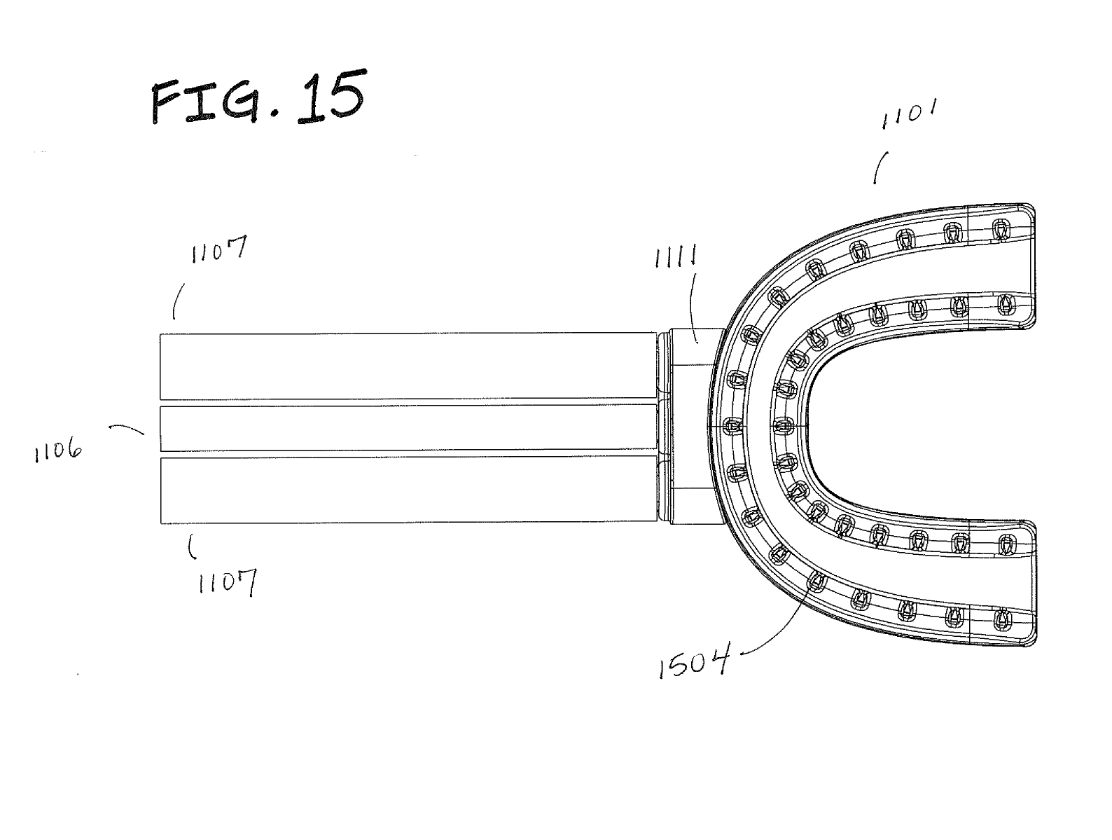

An example of an exit hole is waste funnel 1200 (FIG. 12).

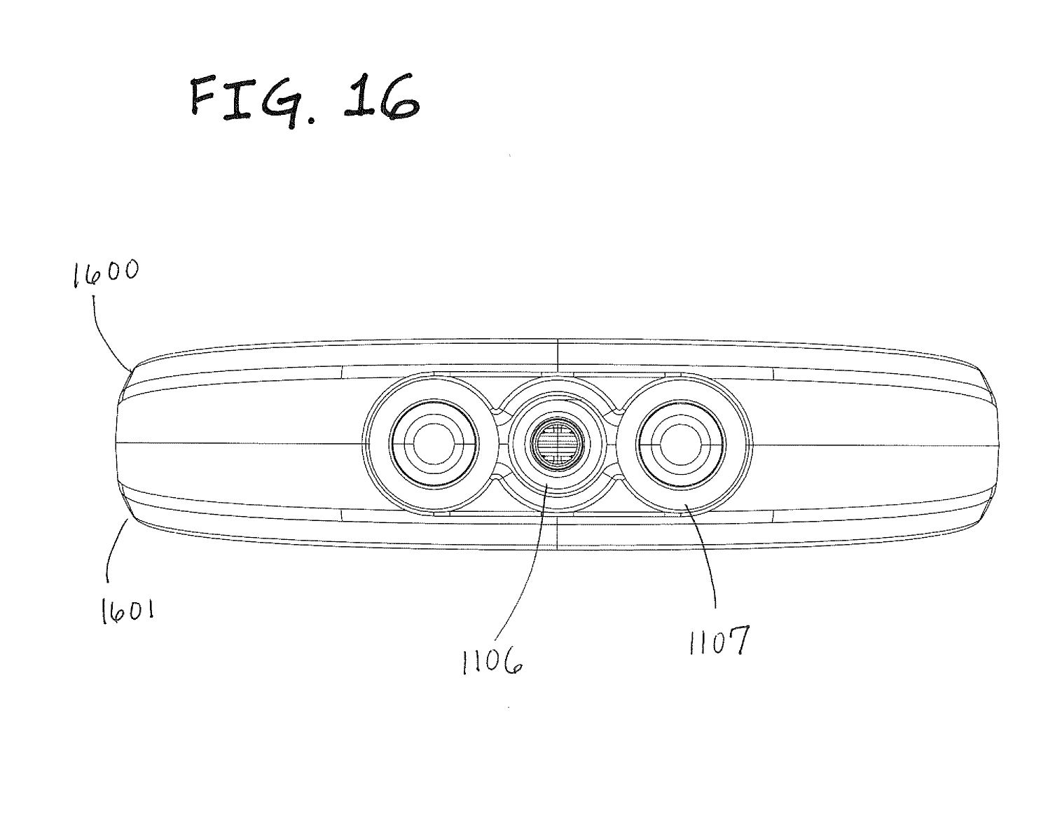

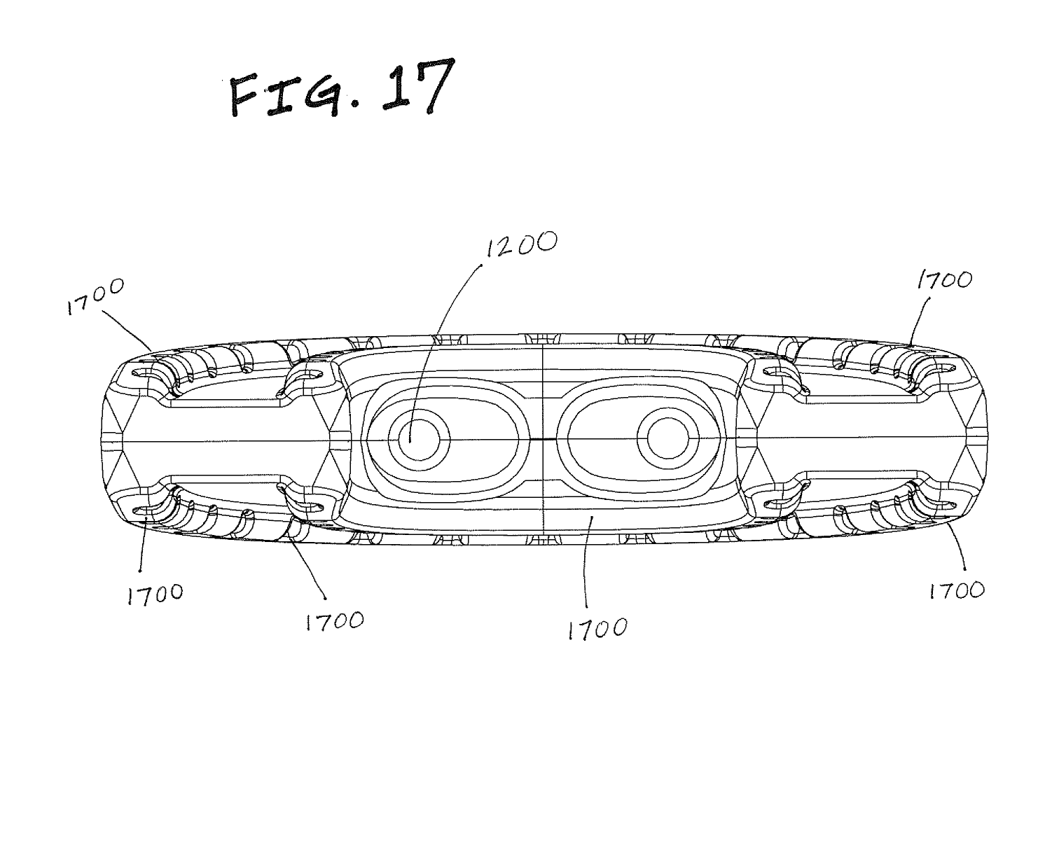

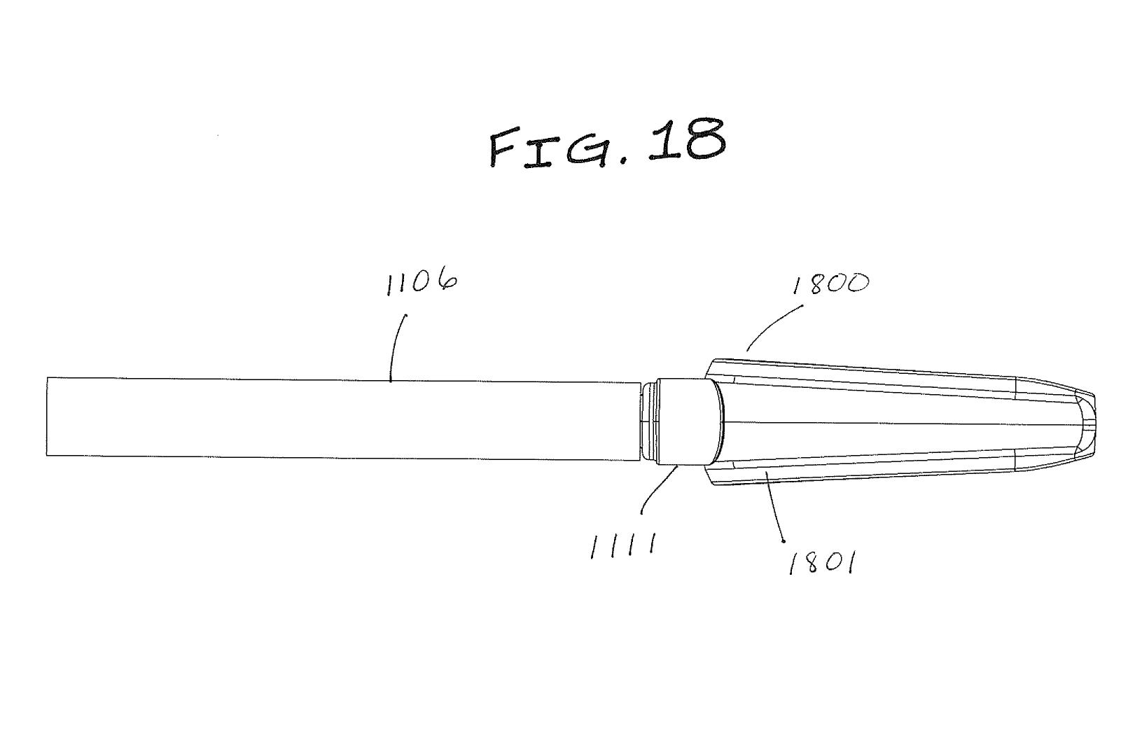

In performing water-direction, an example of a part to use is water director 1201 (FIG. 12) which comprises a water director top 1600 (FIG. 16) and a water director bottom 1601.

In constructing the inventive device, a geometry is used that avoids water going into the throat of the person in whom it is used and that also avoids water spurting out of the front of the mouth. This can be accomplished, for example, by constructing a device based on assuming a same mouth action that keeps mouthwash contained in the mouth during a gargling procedure, such as, e.g., a device with a snorkel-style shape in front, a device with a bulging front that creates a sufficient seal at the front of the mouth, etc.

The invention may be further appreciated with reference to the following examples below, without the invention being limited to the examples.

### Inventive Example 1

### Hydro Clean Auto Floss

The inventive device in this example comprises a molded mouth-guard type mouthpiece 1 configured in a U shape to conform to the contours of a set of human teeth (not shown), having a trough 2 to receive the teeth (while the teeth are within the mouth of the individual receiving the cleaning treatment), further comprising an irrigation water flow component 3 at the front thereof consisting of an attachable tubing apparatus, allowing users to floss all of the teeth by means of pressurized water (not shown), at once, whether at home or on the go. The mouthpiece 1 is molded into a one size fits all model, facilitating a comfortable fit when placed into the mouth (not shown). A series of small circular openings 4 are positioned along the perimeter of the mouthpiece 1, serving as the egress for water. The mouthpiece 1 also features a force fit opening 5, which serves as the attachment point for the irrigation water flow component 3. The irrigation water flow component 3 comprises one central inlet nozzle 6, and two outlet nozzles 7A, 7B, positioned on each side of the inlet nozzle 6. All of these nozzles 6, 7A, 7B are designed to receive tubing by means of a force fit. The hose tubing is intended to be provided with the device. At the opposite end of the inlet hose is a spout adapter 8 that is configured to accommodate most sink faucets.

### Inventive Example 1A

In this example, the device has a small compartment with a cap that is attached to the input line and is filled with mouthwash and squeezed into the input line. The device is packaged withing a durable plastic casing to protect the unit from airborne germs and bacteria when not in use. Various embodiments are produced in a variety of attractive and eye catching colors, as well as various sizes to appeal to and accommodate both adults and children.

### Inventive Example 1b

### Use of the Device

To use the device of Example 1 or 1A, first the user places an encased unit on him- or herself before heading out on an intended activity. By way of example, a business executive slips a unit into his interior coat pocket on his way to work. As another example, a mother embarking on a shopping trip inserts a Hydro Clean Auto Floss system into her purse. After a meal, the user removes the unit from its packaging, and connects the hose to the part to be used in the mouth and to a sink faucet. After inserting the mouthpiece along the teeth, the water from the sink is channeled through the tube and into the mouth, and the pressure is able to remove food particles from between the teeth.

Significant benefits and advantages are associated with this product invention. The Hydro Clean Auto Floss offers consumers a more appealing approach to completing the flossing chore. Due to a specially designed mouthpiece configured with a water hose connector, this product allows users to floss in record time. In this manner, users do not have to uncomfortably strangle their fingers to more effectively accomplish the flossing task. In addition, the models offered by this versatile product line appeal to virtually any user, further encouraging both young and old to add flossing to their dental care regimen. Consumers appreciate that this product not only allows them to look out for their dental health, but is also helpful for overall health and well-being. Not just restricted to household use, domestic and foreign travelers find the Hydro Clean Auto Floss especially convenient. Compact and lightweight, a package of this handy product is easily packed into any shaving kit, travel bag, or carry-on. Hotel guests also enjoy the convenience of the Hydro Clean Auto Floss which can be made available in hotel gift shops and at lobby desks. Offered along with forgotten toothpaste and brush, this provides hotel guests with a quick and sanitary oral solution while they are away from home.

The Hydra Clean Auto Floss is an innovative product invention helpful to increase the number of people who floss on a daily basis. Versatile and convenient, this product is a user-friendly approach to healthy oral hygiene and can be used by adults and children alike.

### Inventive Example 2

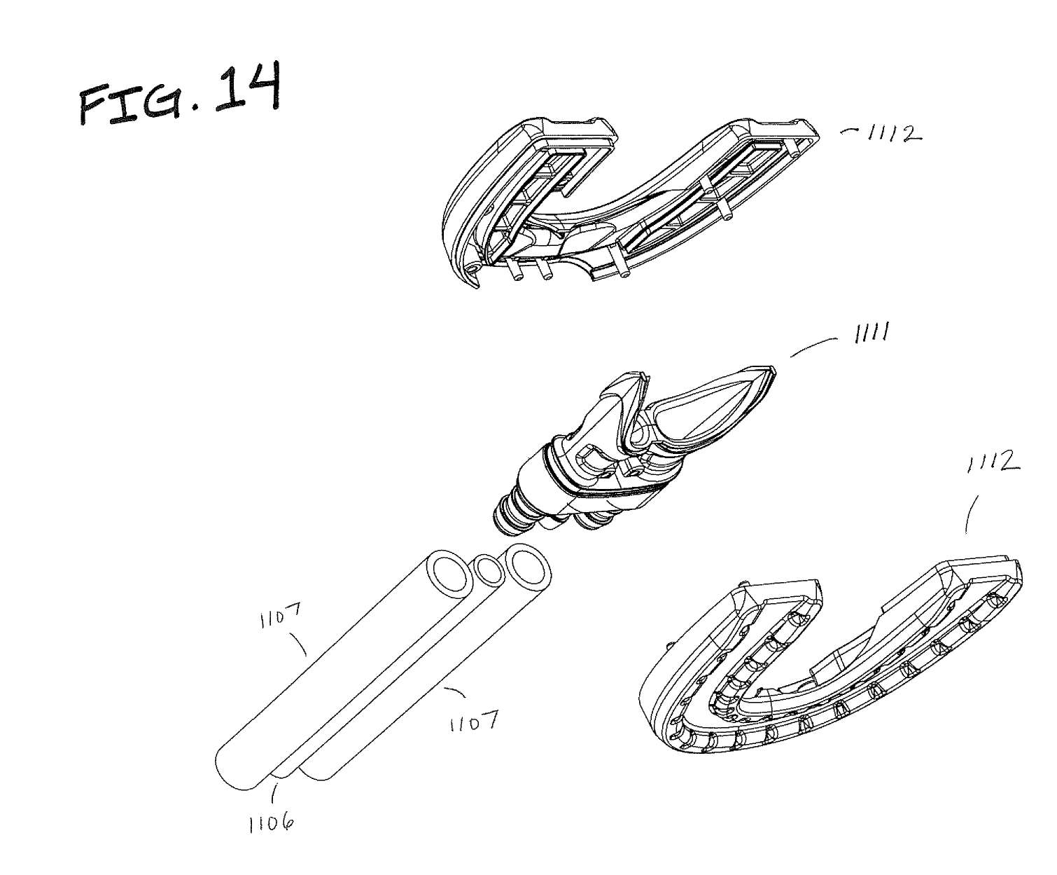

A device was constructed generally along the lines of FIG. 11, comprising a molded mouth-guard type mouthpiece 1101 intended to be used in a mouth and configured in a U shape to conform to the contours of a set of human teeth (not shown), having a trough 1102 to receive the teeth, further comprising an irrigation water flow component 1103 at the front thereof consisting of an attachable tubing apparatus, allowing users to floss all of the teeth by means of pressurized water (not shown), at once, whether at home or on the go. The mouthpiece 1101 is molded as a one size fits all model, facilitating a comfortable fit when placed into the mouth (not shown). A series of openings 1104 are positioned along the perimeter of the mouthpiece 1101, serving as the egress for clean water being ejected from the mouthpiece 1101. The mouthpiece 1101 also comprises a force fit opening 1105, which serves as the attachment point for the irrigation water flow component 1103 to the mouthpiece 1101. The irrigation water flow component 1103 comprises one central inlet nozzle 1106, and two outlet nozzles 1107, positioned on each side of the inlet nozzle 1106. Nozzles 1106, 1107 are designed to receive tubing by means of a force fit.

The device includes a manifold 1111 and a pair of jet channels 1112. The manifold 1111 is constructed to direct pressurized clean water through a collection of water jets to the gums of the mouth being cleaned, while also provided for controlled exit of the dirty water from the mouth to a waste drain. Preferably, manifold 1111 plumbs water inside of the manifold 1111, while directing waste water along outside surfaces of the manifold 1111 to collection channels which have waste tubes attached.

Referring to FIG. 19A, the manifold 1111 is sandwiched between identical nozzles 1113 to create water and waste channels. Mouthpiece 1101 comprises outlet 1114.

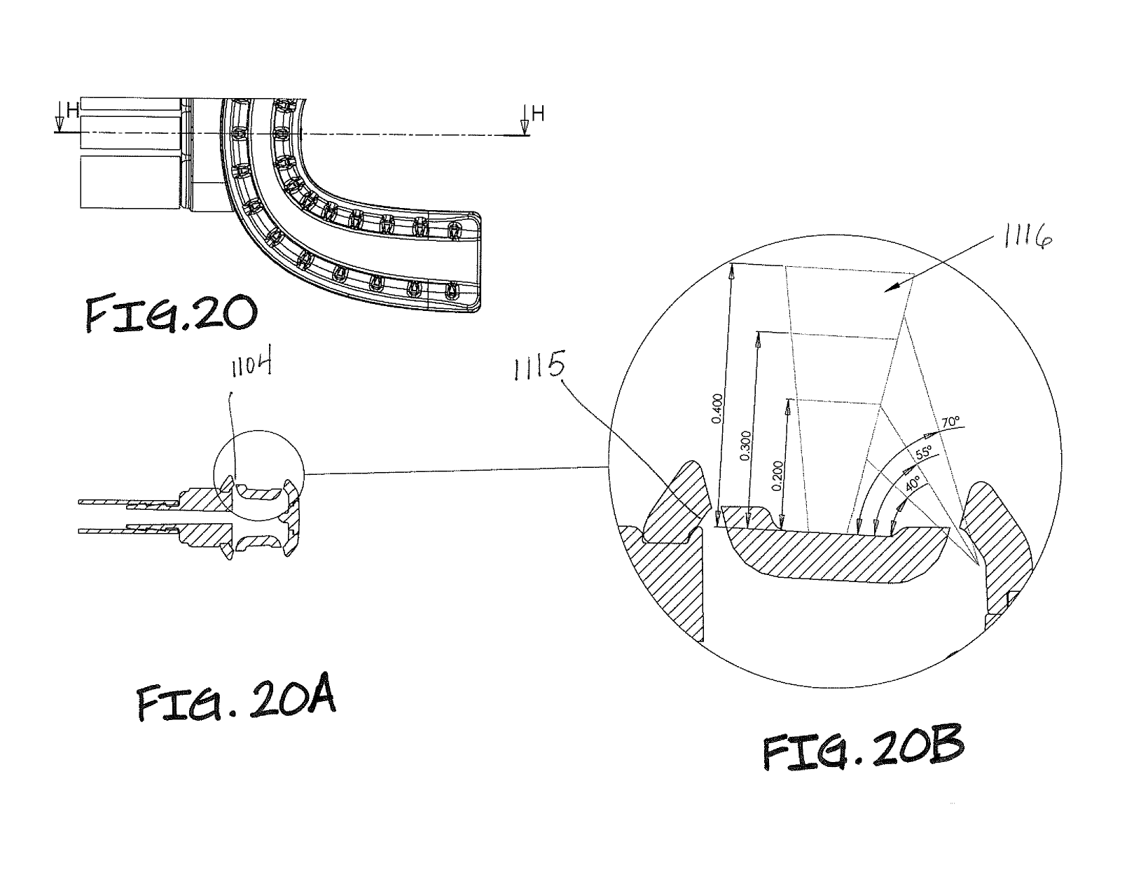

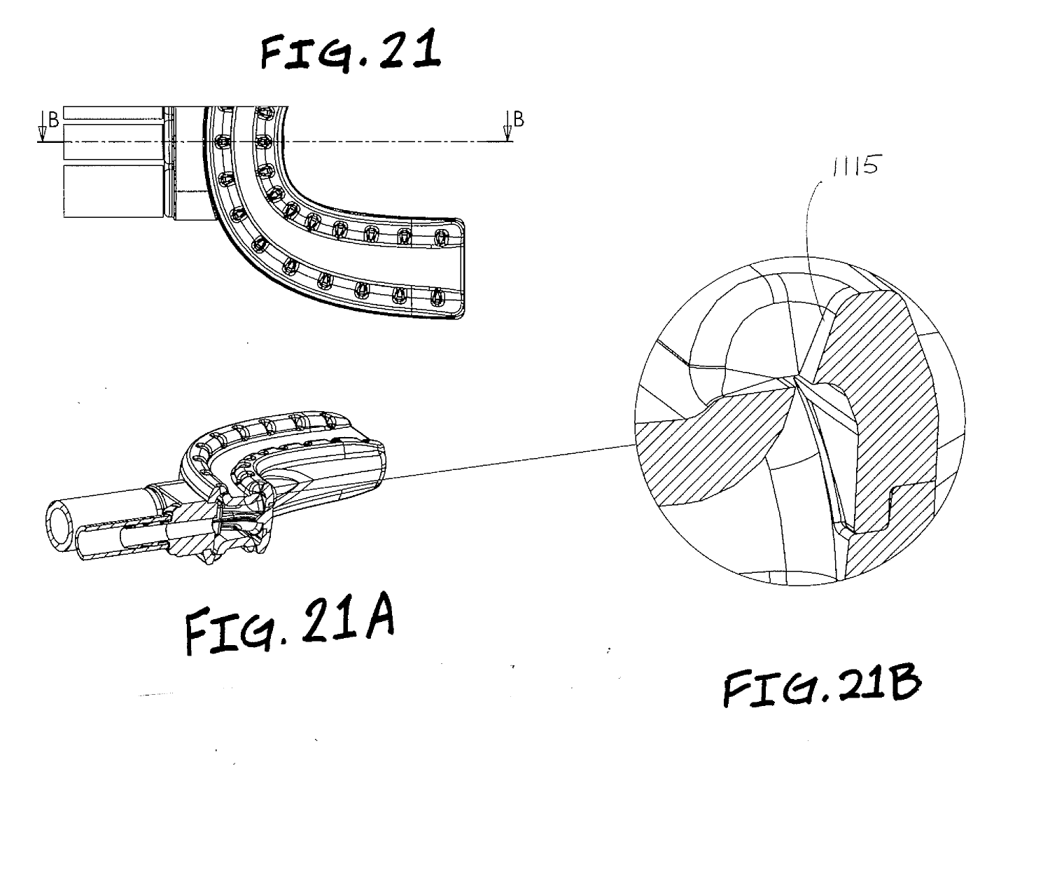

Referring to FIGS. 20-20B, mouthpiece 1101 comprises opening 1104. Deeper in the mouthpiece 1101, opening 1104 has a wider diameter, and on the surface of the mouthpiece 1101 where the clean water is ejected from the device towards the teeth, opening 1104 has a narrower diameter. Particularly, mouthpiece 1101 is constructed with slanted sidewall 1115 (such as a sidewall having a 55 degree slant) in connection with opening 1104. The slanted sidewall 1115 guides the clean water being ejected from the mouthpiece 1101 in an angled trajectory towards the to-be-cleaned parts of the mouth. In FIG. 20B, where the tooth and gum-line extremes 1116 would be, are represented.

Likewise, referring to FIGS. 21-21B, angling of a water jet (not shown) being ejected from the mouthpiece 1101 is created with particular geometry pulled in on tool direction (FIG. 21B), particularly slanted sidewall 1115.

### Inventive Example 2A

A 55 degree sidewall is used for the slant of the slanted sidewall 1115, because 55 degrees represents a mid-range for an effective range of water jet between 40 and 70 degrees (which is a range intended to teach below gums).

To create the 55 degree angle, preferably the jet is formed by a mold pulled directly up and down in regard to the horizontal. As a result, the constructed hole faces up at 90 degrees, yet the jet of clean water leaves the hole at 55 degrees.

### Inventive Example 2B

In a constructed prototype, mouthpiece 1101 has openings 1104 that are water jets that are 0.015 inch by 0.040 inch rectangular slits.

### Inventive Example 2C

In a constructed prototype, mouthpiece 1101 has 68 holes.

### Inventive Example 2D

In a constructed prototype, hoses made of an ether-based polyurethane material were used. The inner diameter of the inlet hose is 0.125 inch. The inner diameter of the exhaust tube is 0.25 inch. The hose length is 10 inches.

It should be appreciated that variations and modifications from the embodiments set forth above may be made without departing from the spirit of the invention, and that such modifications are to be considered within the present invention.

1. A flossing device insertible into a mouth with teeth, comprising:
a mouthpiece having an upper U-shaped cavity and a lower U-shaped cavity into which are received the teeth when the device is in place within the mouth;
a faucet adapter, wherein the faucet adapter comprises a cavity into which is received a faucet in a watertight fit therebetween;
an inlet hose mechanically connected on one end to the mouthpiece and on an opposite end to the faucet adapter;
at least one outlet hose mechanically connected to the mouthpiece.

2. The flossing device of claim 1, comprising two outlet hoses.

3-4. (canceled)

5. The flossing device of claim 1, further comprising a manifold, wherein the manifold comprises a first end that connects to the hoses and a second end that connects to a jet channel part.

6. The flossing device of claim 5, wherein at the manifold the device provides water pressure in a range of about 50 psi to 70 psi.

7. The flossing device of claim 1, wherein the U-shaped mouthpiece comprises a plurality of water jet channels through which water after having traveled from the faucet and through the inlet hose, exits into the mouth.

8. The flossing device of claim 1, wherein the U-shaped mouthpiece comprises a plurality of water collection channels through which are collected water from the mouth, wherein each water collection channel empties towards one or both of the outlet hoses.

9. The flossing device of claim 1, in which used water exits the mouth based on water pressure applied when a faucet is connected to the faucet adapter and the faucet is open, without any suction pump.

10. The flossing device of claim 1, comprising a plurality of water jet holes having a diameter or a dimension in a range of 0.015 inch to 0.05 inch.

11. The flossing device of claim 1, comprising a plurality of water jet holes in a range of 58 holes to 72 holes.

12-14. (canceled)

15. The flossing device of claim 7, comprising at least one water jet channel having a slanted sidewall, wherein the slanted sidewall begins at an inner end relatively inside the device and ends at a water-emerging end where water exits the device into the mouth, and the slanted sidewall is angled such that a cross-section of the water jet at the inner end is wider than a cross-section of the water-jet at the water-emerging end.

16. The flossing device of claim 15, wherein the angle of the slanted sidewall is in a range of about 40 to 70 degrees.

17. The flossing device of claim 16, wherein the angle of the slanted sidewall is about 55 degrees.

18. A flossing device insertible into a mouth with teeth, comprising:
a mouthpiece shaped to fit into the mouth and comprising an upper U-shaped cavity and a lower U-shaped cavity into which are received the teeth;
a faucet adapter, wherein the faucet adapter comprises a cavity into which is received a faucet in a watertight fit therebetween;
at least one outlet through which used water travels away from the mouth;
no suction pump being included in or connected to the flossing device, and no power source being included in or connected to the flossing device.

19. The flossing device of claim 18, including two outlets through which used water travels away form the mouth.

20. A cleaning method for teeth within a mouth, the method not including use of a suction pump, comprising the steps, after a mouthpiece has been inserted into the mouth, of:
delivering water jets into the mouth through a plurality of water jet channels constructed in the mouthpiece, wherein water exiting the mouthpiece has a pressure in a range of about 50 psi to 70 psi measured at the mouthpiece;
dislodging food particles between the teeth by force of the delivered water in the step of delivering water jets;
collecting used water and dislodged food particles from the mouth;
for the used water including food particles that have been collected, receiving used water in at least one outlet hose wherein the used water travels away from the mouth via the outlet hose,
wherein the delivering, dislodging, collecting and receiving steps are performed using a unitary device that comprises the plurality of water jet channels, the mouthpiece, and the outlet hose.

21. The cleaning method of claim 20, wherein the receiving step comprises receiving used water in two outlet hoses.

22. The cleaning method of claim 20, comprising a step of inserting into the mouth a mouthpiece having an upper U-shaped cavity and a lower U-shaped cavity into which are received the teeth when the device is in place, followed by positioning the mouthpiece so that the teeth are within the upper U-shaped cavity and the lower U-shaped cavity.

23. The cleaning method of claim 20, including, before the step of delivering water into the mouth, attaching a faucet adapter to a faucet, followed by turning on the faucet and receiving water from the turned-on faucet through the faucet adapter, which water is channeled for use in the delivering step.

24. The cleaning method of claim 20, practiced in connection with manually turning on a standard faucet, and practiced without operating any suction pump, and further practiced without operating any motorized device.

25. The cleaning method of claim 20, wherein the step of delivering water jets includes angling a water jet, upon exiting a hole, at an angle wherein the water jet travels an angled path in a range of 40 to 70 degrees from horizontal.

26-27. (canceled)
